(19) United States
(12) Patent Application Publication
(10) Pub. No.: US 2025/0272813 A1
(43) Pub. Date: Aug. 28, 2025

(54) IMAGE ASSESSMENT METHOD AND APPARATUS, AND DEVICE, STORAGE MEDIUM AND PROGRAM PRODUCT

(71) Applicant: Beijing Zitiao Network Technology Co., Ltd., Beijing (CN)

(72) Inventors: Jing WANG, Beijing (CN); Haotian FAN, Beijing (CN); Xiaoxia HOU, Beijing (CN)

(21) Appl. No.: 18/857,412

(22) PCT Filed: May 9, 2023
(86) PCT No.: PCT/CN2023/092934

§ 371 Date: Oct. 16, 2024

(30) Foreign Application Priority Data
May 13, 2022 (CN) 202210524525.X

(51) Int. Cl. G06T 7/00; G06T 3/4046; G06T 7/11

(52) U.S. Cl. CPC G06T 7/0002; G06T 3/4046; G06T 7/11; G06T 2207/20021; G06T 2207/20081; G06T 2207/20084; G06T 2207/30168

(57) ABSTRACT

The present disclosure relates to an image assessment method and apparatus, and a device, a storage medium and a program product. The method comprises: acquiring an image to be assessed; and inputting said image to be assessed into an image assessment model, so as to obtain a quality assessment result corresponding to said image to be assessed, wherein the image assessment model comprises: a multilevel transformation network, a fusion network and a fully connected layer; the multilevel transformation network is used for processing said image to be assessed to obtain image features, which are output by each layer of transformation network; the fusion network is used for fusing the image features, which are output by the each layer of transformation network, so as to obtain a fused image feature; and the fully connected layer is used for processing the fused image feature to obtain the quality assessment result.

### CROSS-REFERENCE TO RELATED APPLICATIONS

The present application is a National Stage Entry of International application No. PCT/CN2023/092934 filed on May 9, 2023, which based on and claims the priority to the Chinese application No. 202210524525.X filed on May 13, 2022, and entitled “IMAGE ASSESSMENT METHOD AND APPARATUS, AND DEVICE, STORAGE MEDIUM AND PROGRAM PRODUCT”, the disclosures of both applications are incorporated by reference herein in their entireties.

### TECHNICAL FIELD

The present disclosure relates to the technical field of image processing, and in particular, to an image assessment method and apparatus, a device, a storage medium and a program product.

### BACKGROUND

Image quality assessment (IQA) can be divided into subjective scoring and objective scoring. In the subjective scoring, multiple rounds of scoring are performed by multiple persons on an image to be assessed and a mean is taken to characterize a perceived quality of the image, so that the subjective scoring is accurate but often time-consuming and laborious. The objective scoring is, by training a general image assessment model, automatically assessing a perceived quality of an image to be assessed through the image assessment model, and fitting human subjective judgments to a maximum extent. The image assessment model for the objective scoring can be divided into three categories, namely a full-reference algorithm, a reduced-reference algorithm and a no-reference algorithm according to whether there is a reference image in the training process.

In the full-reference algorithm, quality of a distorted image is assessed by comparing a difference between the distorted image and an original image. However, for a practical task, reference images are often difficult to acquire, and even some images do not have reference images, for example, GAN images. In the case where a reference image is unknown, the no-reference algorithm needs to be used for the image quality assessment.

### SUMMARY

In order to solve the above technical problem, an embodiment of the present disclosure provides an image assessment method and apparatus, device, storage medium and program product, which can, after a plurality of features in an image are extracted and fused, assess an image quality according to the fused feature, improving accuracy and stability of a prediction result.

In a first aspect, an embodiment of the present disclosure provides an image assessment method, comprising:
acquiring an image to be assessed; and
inputting the image to be assessed into an image assessment model to obtain a quality assessment result corresponding to the image to be assessed, wherein the image assessment model comprises: a multilevel transformation network, a fusion network and a fully connected layer, the multilevel transformation network being used for processing the image to be assessed to obtain image features output by each level of transformation network, the fusion network being used for fusing the image features output by the each level of transformation network to obtain a fused image feature, and the fully connected layer being used for processing the fused image feature to obtain the quality assessment result.

In a second aspect, an embodiment of the present disclosure provides an image assessment apparatus, comprising:
an image acquisition module configured to acquire an image to be assessed;
an image assessment module configured to input the image to be assessed to an image assessment model to obtain a quality assessment result corresponding to the image to be assessed, wherein the image assessment model comprises: a multilevel transformation network, a fusion network and a fully connected layer, the multilevel transformation network being used for processing the image to be assessed to obtain image features output by each level of transformation network, the fusion network being used for fusing the image features output by the each level of transformation network to obtain a fused image feature, and the fully connected layer being used for processing the fused image feature to obtain the quality assessment result.

In a third aspect, an embodiment of the present disclosure provides an electronic device, comprising:
one or more processors; and
storage means configured to store one or more programs,
the one or more programs, when executed by the one or more processors, causing the one or more processors to implement the image assessment method as described in the first aspect above.

In a fourth aspect, an embodiment of the present disclosure provides a computer-readable storage medium having thereon stored a computer program which, when executed by a processor, implements the image assessment method as described in the first aspect above.

In a fifth aspect, an embodiment of the present disclosure provides a computer program product, comprising a computer program or instructions which, when executed by a processor, implement the image assessment method as described in the first aspect above.

In a sixth aspect, an embodiment of the present disclosure provides a computer program, comprising: instructions which, when executed by a processor, cause the processor to implement the image assessment method as described in the first aspect above.

The embodiments of the present disclosure provide an image assessment method and apparatus, and a device, a storage medium and a program product, the method comprising: acquiring an image to be assessed; inputting the image to be assessed into an image assessment model to obtain a quality assessment result corresponding to the image to be assessed, wherein the image assessment model comprises: a multilevel transformation network, a fusion network and a fully connected layer, the multilevel transformation network being used for processing the image to be assessed to obtain image features output by each level of transformation network, the fusion network being used for fusing the image features output by the each level of transformation network to obtain a fused image feature, and the fully connected layer being used for processing the fused image feature to obtain the quality assessment result. According to the embodiments of the present disclosure, after a plurality of image features in an image are extracted by a multilevel transformation network, the plurality of image features are fused by using a fusion network, and image quality is assessed according to the fused feature by using a fully connected layer, improving accuracy and stability of a prediction result.

### BRIEF DESCRIPTION OF THE DRAWINGS

The above and other features, advantages, and aspects of the embodiments of the present disclosure will become more apparent by combining the accompanying drawings and referring to the following DETAILED DESCRIPTION. Throughout the drawings, the same or similar reference numbers refer to the same or similar elements. It should be understood that the drawings are schematic and that components and elements are not necessarily drawn to scale.

FIG. 1 shows an architecture diagram of an image assessment scenario according to an embodiment of the present disclosure;

FIG. 2 is a schematic flow diagram of an image assessment method according to an embodiment of the present disclosure;

FIG. 3 is a schematic structural diagram of an image assessment model according to an embodiment of the present disclosure;

FIG. 4 is a schematic flow diagram of an image assessment model training method according to an embodiment of the present disclosure;

FIG. 5 is a schematic structural diagram of an image assessment apparatus according to an embodiment of the present disclosure;

FIG. 6 is a schematic structural diagram of an electronic device according to an embodiment of the present disclosure.

### DETAILED DESCRIPTION

The embodiments of the present disclosure will be described in more detail below with reference to the accompanying drawings. While certain embodiments of the present disclosure are shown in the drawings, it should be understood that the present disclosure may be implemented in various forms and should not be construed as limited to the embodiments set forth herein, which are provided for a more complete and thorough understanding of the present disclosure instead. It should be understood that the drawings and the embodiments of the present disclosure are for exemplary purposes only and are not intended to limit the scope of protection of the present disclosure.

It should be understood that various steps recited in method implementations of the present disclosure may be performed in a different order, and/or performed in parallel. Furthermore, the method implementations may include additional steps and/or omit performing the illustrated steps. The scope of the present disclosure is not limited in this respect.

The term “including” and variations thereof used herein are intended to be open-ended, i.e., “including but not limited to”. The term “based on” is “at least partially based on”. The term “one embodiment” means “at least one embodiment”; the term “another embodiment” means “at least one other embodiment”; and the term “some embodiments” means “at least some embodiments”. Definitions related to other terms will be given in the following description.

It should be noted that the concepts “first”, “second”, and the like mentioned in the present disclosure are only used for distinguishing different devices, modules or units, and are not used for limiting the order or interdependence of functions performed by the devices, modules or units.

It should be noted that modifications of “a” or “a plurality” mentioned in this disclosure are intended to be illustrative rather than restrictive, and that those skilled in the art should appreciate that they should be understood as “one or more” unless otherwise explicitly stated in the context.

Names of messages or information exchanged between a plurality of devices in the implementations of the present disclosure are for illustrative purposes only, and are not intended to limit the scope of the messages or information.

FIG. 1 illustrates an architecture diagram of an image assessment scenario according to an embodiment of the present disclosure.

As shown in FIG. 1, the architecture diagram may include at least one electronic device 101 at a client side and at least one server 102 at a server side. The electronic device 101 may establish a connection with the server 102 through a network protocol, such as a hypertext transfer protocol over secure socket layer (HTTPS), and perform information interaction. For example: the electronic device 101 may be a mobile terminal, a fixed terminal, or a portable terminal, such as a mobile phone, site, unit, device, a multimedia computer, a multimedia tablet, an Internet node, a communicator, a desktop computer, a laptop computer, a notebook computer, a netbook computer, a tablet computer, a personal communication system (PCS) device, a personal navigation device, a personal digital assistant (PDA), an audio/video player, a digital camera/video camera, a positioning device, a television receiver, a radio broadcast receiver, an e-book device, a gaming device, or any combination thereof, including accessories and peripherals of these devices, or any combination thereof. The server 102 may be an entity server or a cloud server, and the server may be one server or a server cluster.

In the embodiment of the present disclosure, in order to improve accuracy and stability of image assessment, the electronic device 101 is capable of receiving an image to be assessed input by a user, and after the electronic device 101 receives the image to be assessed, the image to be assessed is input to an image assessment model, and is processed by using a multilevel transformation network included in the image assessment model, to obtain image features output by each level of transformation network, then, the image features output by each level of transformation network are fused by using a fusion network to obtain a fused image feature, and finally, the fused image feature is processed by using a fully connected layer to obtain a quality assessment result. It can be seen that, after a plurality of image features in the image are extracted through the multilevel transformation network, the plurality of image features are fused by using the fusion network, and the image quality is assessed according to the fused feature by using the fully connected layer, improving accuracy and stability of a prediction result.

Optionally, based on the above architecture, after the electronic device 101 receives the image to be assessed, the image to be assessed is input to an image assessment model at the electronic device 101 locally, and the image to be assessed is processed by using the image assessment model to output an image quality assessment result corresponding to the image to be assessed, so as to reduce time cost of the image assessment.

Optionally, based on the above architecture, the electronic device 101 may further send an image assessment request carrying the image to be assessed to the server 102 after receiving the image to be assessed. The server 102 may, after receiving the image assessment request carrying the image to be assessed that is sent by the electronic device 101, in response to the image assessment request, input the image to be assessed to the image assessment model, process the image to be assessed by using the image assessment model, output an image quality assessment result corresponding to the image to be assessed, and send the generated image quality assessment result to the electronic device 101, so that the electronic device 101 may display the above image quality assessment result to reduce the data processing amount of the electronic device 101.

The image assessment method according to the embodiment of the present application will be described in detail below in conjunction with the accompanying drawings.

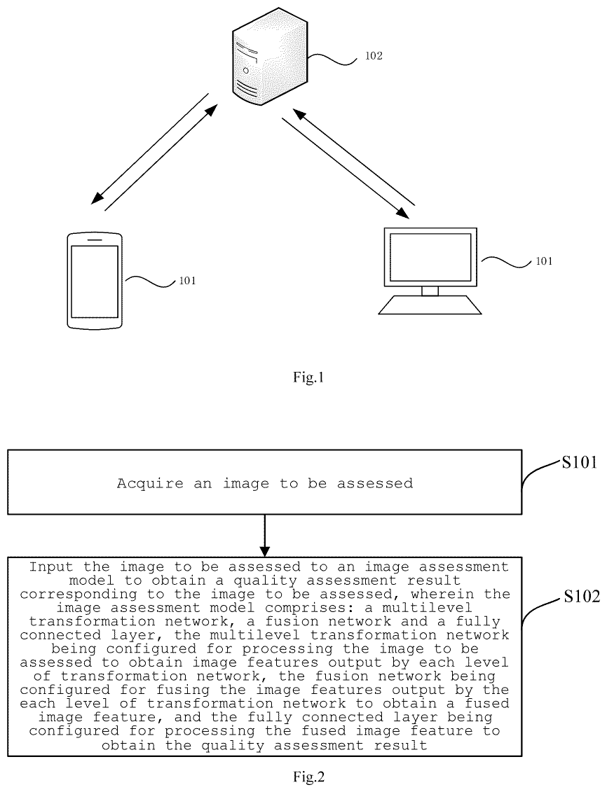

FIG. 2 is a flow diagram of an image assessment method according to an embodiment of the present disclosure; the embodiment is applicable to the case of image quality assessment without a reference image, the method may be performed by an image assessment apparatus, the image assessment apparatus may be implemented in software and/or hardware, and the image assessment apparatus may be configured in an electronic device.

As shown in FIG. 2, the image assessment method according to the embodiment of the present disclosure mainly comprises steps S101 to S103.

S101, acquiring an image to be assessed.

The image to be assessed can be understood as an image whose image quality shall be assessed. The image to be assessed can include traditional degraded image data, or an enhanced image processed by algorithms such as super-resolution and denoising.

In the embodiment of the present disclosure, the acquiring the image to be assessed may be acquiring an image needing image quality assessment from a local image repository, or may be downloading an image needing image quality assessment from the Internet. The specific manner of acquiring the image to be assessed is not limited in this embodiment.

In an implementation of the present disclosure, the image to be assessed is processed to obtain an image to be assessed with a preset size, wherein the preset size is 384×384 or 224×224.

S102, inputting the image to be assessed to an image assessment model to obtain a quality assessment result corresponding to the image to be assessed, wherein the image assessment model comprises: a multilevel transformation network, a fusion network and a fully connected layer, the multilevel transformation network being used for processing the image to be assessed to obtain image features output by each level of transformation network, the fusion network being used for fusing the image features output by the each level of transformation network to obtain a fused image feature, and the fully connected layer being used for processing the fused image feature to obtain the quality assessment result.

In an implementation of the present disclosure, a neural network model to be trained is trained by using a sample image set to obtain the image assessment model. Specifically, the neural network model to be trained is trained by the sample image set, and the model has a self-learning capability, so that the trained model has functions of extracting an image feature and performing image assessment.

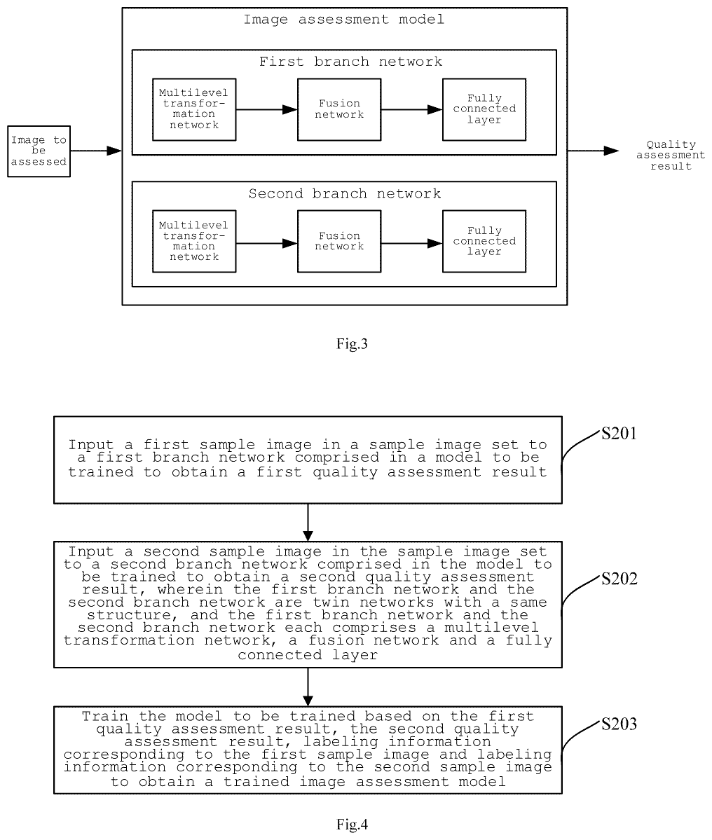

In an implementation of the present disclosure, as shown in FIG. 3, the image assessment model is a twin network with a same network structure and a same model parameter, the twin network includes a first branch network and a second branch network, and the first branch network and the second branch network each includes a multilevel transformation network, a fusion network, and a fully connected layer.

In an implementation of the present disclosure, after the image to be assessed is input to the image assessment model, the image assessment model may select any of the branch networks to process the image to be assessed, and the image assessment model outputs a quality assessment result.

In an implementation of the present disclosure, the image assessment model has two input ends, respectively corresponding to an input end of the first branch network and an input end of the second branch network, a user can select any of the input ends to input the image to be assessed to the image assessment model, the image to be assessed is processed by the branch network corresponding to the input end, and the image assessment model outputs a quality assessment result.

In an implementation of the present disclosure, the quality assessment result may include an image score output by the image assessment model, or an image grade output by the image assessment model, for example: excellent, good, medium, poor, and the like.

In an implementation of the present disclosure, the multilevel transformation network is an attention transformer network with a multi-level structure, and is used for extracting image features in the image to be assessed from a plurality of different perspectives, that is, each level extracts an image feature in the image to be assessed from its respective perspective. The multilevel transformation network has one input end and a plurality of output ends, wherein the input end is used for receiving the input image to be assessed, and the output ends are used for outputting image features output by each level of transformation network. The image features include: texture feature, color feature, context feature, exposure feature, and other perspectives. In the embodiment of the present disclosure, the image features can be extracted from different perspectives by using the multilevel transformation network to improve accuracy of image identification.

In an implementation of the present disclosure, the fusion network has a plurality of input ends and one output end, the input ends being used for receiving the image features output by the each level of transformation network, and the output end being used for outputting a fused feature. The fusion network is used for fusing the plurality of image features output by the each level of transformation network to obtain a fused image feature. In this way, information contained in the image features for prediction can be greatly increased.

The fully connected layer is one of various components of a multi-layer perceptron which are applied in a convolutional neural network. In a deep learning field, several last layers of network structures of the convolutional neural network model for a classification task are often fully connected layers, for mapping feature representation vectors obtained from several feature extraction layers before the fully connected layers to a next layer, or to a final softmax layer.

In an implementation of the present disclosure, the fully connected module used is a double-layer structure, wherein the first layer is activated by using a GELU activation function.

The image assessment model further comprises: a sliding window, the sliding window being used for segmenting the input image to be assessed to obtain a plurality of image blocks, and inputting the image blocks to the multilevel transformation network.

In the embodiment of the present disclosure, the image assessment model further comprises a sliding window, wherein the sliding window segments the image to be assessed into a plurality of image blocks; each image block is inputted into the multilevel transformation network, to obtain image block features output by each level of transformation network corresponding to the image block, and then the image block features output by the each level of transformation network corresponding to the plurality of image blocks are fused to obtain the fused image feature.

In a possible implementation, an image block size is 4×4, and a sliding window size is set to 7×7.

In the embodiment of the present disclosure, the image assessment model divides the image to be assessed into a plurality of image blocks, and extracts features of the image blocks to extract more information from the image, thereby enhancing accuracy of image assessment.

The embodiment of the present disclosure provides an image assessment method, comprising: acquiring an image to be assessed; inputting the image to be assessed into an image assessment model to obtain a quality assessment result corresponding to the image to be assessed, wherein the image assessment model comprises: a multilevel transformation network, a fusion network and a fully connected layer, the multilevel transformation network being used for processing the image to be assessed to obtain image features output by each level of transformation network, the fusion network being used for fusing the image features output by the each level of transformation network to obtain a fused image feature, and the fully connected layer being used for processing the fused image feature to obtain the quality assessment result. According to the embodiment of the present disclosure, after a plurality of image features in the image are extracted by the multilevel transformation network, the plurality of image features are fused by using the fusion network, and the image quality is assessed according to the fused feature by using the fully connected layer, improving accuracy and stability of a prediction result.

On the basis of the above embodiment, an embodiment of the present disclosure provides another image assessment method, mainly comprising: dividing the image to be assessed to obtain a plurality of sub-images to be assessed; for one or more of the sub-images to be assessed, inputting the sub-image to be assessed into the image assessment model to obtain a quality assessment result corresponding to the sub-image to be assessed; and determining the quality assessment result of the image to be assessed based on the quality assessment results corresponding to the one or more of the sub-images to be assessed.

In the embodiment of the present disclosure, the segmenting the image to be assessed to obtain a plurality of image blocks refers to, after the image to be assessed is input to the image assessment model, achieving image blocks segmenting by a sliding window provided in the image assessment model. The dividing the image to be assessed to obtain a plurality of sub-images to be assessed refers to, before the image to be assessed is input into the image assessment model, dividing the image to be assessed to obtain the plurality of sub-images to be assessed.

In an implementation of the present disclosure, for each sub-image to be assessed, the process of inputting the sub-image to be assessed to the image assessment model to obtain a quality assessment result corresponding to the sub-image to be assessed is performed. The processing by the image assessment model for the sub-image to be assessed is the same as the processing by the image assessment model for the image to be assessed provided in the above embodiment, so that reference may be specifically made to the description in the above embodiment, and specific limitations are not made in this embodiment.

In the embodiment of the present disclosure, the image to be assessed is divided into the plurality of sub-images to be assessed to acquire more image information, enhancing accuracy and stability of a prediction result.

The determining the quality assessment result of the image to be assessed based on the quality assessment results corresponding to the plurality of sub-images to be assessed, comprises: calculating a harmonic mean corresponding to the quality assessment results corresponding to the plurality of sub-images to be assessed; and determining the harmonic mean as the quality assessment result of the image to be assessed.

In an implementation of the present disclosure, for the quality assessment results of the sub-images to be assessed, a mean is calculated by means of harmonic mean, as the final quality assessment result of the image to be assessed. Specifically, the harmonic mean formula is as follows.

$$harmonic\_mean = \frac{n}{\sum \frac{1}{x i}}$$

where n represents the number of the sub-images to be assessed, and xi represents the quality assessment result of each sub-image to be assessed.

In the embodiment of the present disclosure, the final quality assessment result of the image is calculated by using the harmonic mean, enhancing accuracy and stability of the prediction result.

On the basis of the above embodiment, an embodiment of the present disclosure provides a training method for an image assessment model, as shown in FIG. 4, the training method for an image assessment model provided in the embodiment of the present disclosure mainly comprising:
S201, inputting a first sample image in a sample image set to a first branch network comprised in a model to be trained, to obtain a first quality assessment result.

In the embodiment of the present disclosure, some manners of preprocessing the image in the sample image set are provided first.

In an implementation of the present disclosure, the manner of acquiring the sample image set mainly includes: capturing images from the network through crawler software, using images processed by a GAN, using images taken by a video camera, and the like.

In an implementation of the present disclosure, the method further comprises: for at least one sample image in the sample image set, zooming the sample image to obtain a sample image with a preset resolution; and preprocessing the sample image with the preset resolution by using an enhancement strategy, the enhancement strategy being used for improving richness of the sample image set.

In an implementation of the present disclosure, for each sample image collected into the sample image set, the sample image is first zoomed to the preset resolution without distortion, and then one sub-sample image is intercepted from a random position as an input of the image assessment model, to train the image assessment model.

The above enhancement strategy includes rotating the sample image by different angles, converting the sample image to a plurality of color spaces, etc., to acquire more sample images.

Since an IQA dataset for subjective labeling tends to be small, data augmentation is performed by using the enhancement strategy upon the training.

In an implementation of the present disclosure, the preprocessing the sample image with the preset resolution by using the enhancement strategy, comprises at least one of: rotating the sample image with the preset resolution by a preset angle; or converting the sample image with the preset resolution into a set color space. The set color space comprises one or more of: an RGB color space, an HSV color space, an LAB color space, and a Grayscale color space.

The preset angle may include 90 degrees, 180 degrees, 270 degrees, and the like. By randomly rotating the sample image with the preset resolution in the original size, a plurality of sample images with different angles can be obtained.

That is, The sample image with the preset resolution is randomly converted into: the RGB color space, HSV color space, LAB color space, and Grayscale color space. The two enhancement methods both have no significant impact on the image quality, but can increase the richness of the data set.

In an implementation of the present disclosure, the method further comprises: if labeling information corresponding to each sample image in the sample image set is unevenly distributed, performing weighted upsampling on the labeling information corresponding to each sample image to obtain labeling information with a weight.

The labeling information corresponding to the sample image refers to a result of performing subjective assessment manually on the sample image, which can be a subjective score for the sample image. Specifically, it may be an MOS (mean opinion score).

That the labeling information corresponding to the sample image is unevenly distributed can be understood as, as a result of uneven quality of the obtained sample images, too many sample images with scores located in a first score interval and too few sample images with scores located in a second score interval.

In the embodiment of the present disclosure, for a sample image set with extremely uneven distribution of MOS intervals, in the preprocessing process, weighted up-sampling is performed on the sample image set according to relative distribution, to balance distributions of images of various qualities, so that an unbiased model is learned by a network.

In an implementation of the present disclosure, a first sample image in a sample image set is input to a first branch network comprised in a model to be trained to obtain a first quality assessment result. Specifically, a multilevel transformation network in the first branch network processes the first sample image to obtain first sample image features output by each level of transformation network, a fusion network in the first branch network fuses the first sample image features output by the each level of transformation network to obtain a fused first sample image feature, and a fully connected layer in the first branch network processes the fused first sample image feature to obtain the first quality assessment result.

S202, inputting a second sample image in the sample image set to a second branch network comprised in the model to be trained to obtain a second quality assessment result, wherein the first branch network and the second branch network are twin networks with a same structure, and the first branch network and the second branch network each comprises a multilevel transformation network, a fusion network and a fully connected layer.

In an implementation of the present disclosure, a second sample image in the sample image set is input to a second branch network comprised in the model to be trained to obtain a second quality assessment result. Specifically, a multilevel transformation network in the second branch network processes the second sample image to obtain second sample image features output by each level of transformation network, a fusion network in the second branch network fuses the second sample image features output by the each level of transformation network to obtain a fused second sample image feature, and a fully connected layer in the second branch network processes the fused second sample image feature to obtain a second quality assessment result.

The first sample image and the second sample image are two different sample images in the sample image set.

S203, training the model to be trained based on the first quality assessment result, the second quality assessment result, labeling information corresponding to the first sample image and labeling information corresponding to the second sample image to obtain a trained image assessment model.

In an implementation of the present disclosure, the training the model to be trained based on the first quality assessment result, the second quality assessment result, the labeling information corresponding to the first sample image, and the labeling information corresponding to the second sample image to obtain the trained image assessment model, comprises: training the model to be trained by using a joint loss function based on the first quality assessment result, the second quality assessment result, the labeling information corresponding to the first sample image and the labeling information corresponding to the second sample image to obtain the trained image assessment model, wherein the joint loss function comprises a regression loss function and a rank loss function, the regression loss function being used for measuring a difference between the first quality assessment result and the labeling information corresponding to the first sample image, and the rank loss function being used for measuring a relative quality between the first sample image and the second sample image.

In the embodiment of the present disclosure, in the training process of the image assessment model, joint optimization is performed by using both the regression loss function and the rank loss function.

The regression loss function measures an absolute difference between a predicted assessment result and a mean opinion score, optimizing an absolute score regarding each image quality. The rank loss function is used for optimizing a relative quality between the images. The predicted assessment result refers to a quality assessment result of the sample image output by the image assessment model after the sample image is input into the image assessment model, and the predicted assessment result may be a predicted score. The mean opinion score refers to a subjective score for the sample image.

The regression loss function makes the predicted score closer to the mean opinion score, improving accuracy of assessment of the model, and the rank loss function greatly enriches the information amount used upon the training, making the model have a better prediction result while having a faster convergence speed.

In an implementation of the present disclosure, the training the model to be trained by using the joint loss function based on the first quality assessment result, the second quality assessment result, the labeling information corresponding to the first sample image, and the labeling information corresponding to the second sample image to obtain the trained image assessment model, comprises: determining a first loss function value based on the regression loss function, the first quality assessment result, the second quality assessment result, the labeling information corresponding to the first sample image and the labeling information corresponding to the second sample image, wherein the first loss function value is used for characterizing a relative difference between the first quality assessment result and the labeling information corresponding to the first sample image, and a relative difference between the second quality assessment result and the labeling information corresponding to the second sample image; determining a second loss function value based on the rank loss function, the first quality assessment result, the second quality assessment result, the labeling information corresponding to the first sample image and the labeling information corresponding to the second sample image, wherein the second loss function value is used for characterizing the relative quality between the first sample image and the second sample image; and optimizing a parameter in the model to be trained based on the first loss function value and the second loss function value to obtain the trained image assessment model.

In the embodiment of the present disclosure, the first loss function value loss_{reg} is a loss value calculated by the regression loss function, which is a Euclidean distance between the predicted score and the mean opinion score that characterizes a relative difference therebetween.

$${loss}_{r e g} = \frac{1}{2 N} {\sum }_{i = 1 : N} {⌊ - {y}_{i} ⌋}^{2}$$

where [symbol] and yᵢ represent the predicted score and the mean opinion score of the image quality, respectively. N represents the number of sample images in one training batch.

In the embodiment of the present disclosure, the second loss function value lossᵣₐₙₖ is used for measuring whether a relative rank between two input sample images matches a true value to a certain extent. For the two input sample images, a difference between predicted scores of the two is calculated to characterize the relative quality between the two, and the difference is compared with a relative magnitude between the mean opinion scores of the two, specifically:

$${loss}_{rank} = \frac{2}{N} {\sum }_{i = 0 : 2 : N} \{ \begin{matrix}{e}^{{\hat{y}}^{i} - {\hat{y}}^{i + 1}} , if {e}^{{y}^{i} < {y}^{i + 1}} \\ 0 , other\end{matrix}$$

The use of the rank loss function enables the model to learn not only the absolute value of the image score, but also the relative relationship between two image scores, which greatly enriches the information amount used upon the training, making the model have a better prediction performance while having a faster convergence speed. The structure of the twin network takes image pairs as inputs, and adapts to the Rank loss function.

The embodiment of the present disclosure, in view of the above no-reference scoring problem, provides a no-reference image assessment method, which can achieve a better result than the existing algorithm on a data set of general images, and can also achieve a better performance on an image processed by an enhanced algorithm, especially on an image generated by GAN technology. This solution uses a Swin Transformer-based multilevel feature fusion network and selects an appropriate loss function and a training strategy to optimize the model. The loss function comprises a regression loss and a rank loss. The regression loss function measures the absolute difference between the predicted score and the true score, optimizing the absolute score regarding each image quality. The rank loss function is used for optimizing a relative quality between the images. The training strategy comprises twin network-based image pair training, data enhancement, weighted sampling and the like. The embodiment of the present disclosure achieves a better performance on a plurality of sample image sets, which include a traditional degraded image set and an enhanced image set processed by algorithms such as super-resolution and denoising. When performing perceived quality assessment, the image assessment model according to the embodiment of the present disclosure can obtain results similar to human subjective scores in different scenarios.

FIG. 5 is a schematic structural diagram of an image assessment apparatus according to an embodiment of the present disclosure; the embodiment is applicable to the case of image quality assessment without a reference image, the image assessment apparatus may be implemented in software and/or hardware, and the image assessment apparatus may be configured in an electronic device.

As shown in FIG. 5, the image assessment apparatus according to the embodiment of the present disclosure mainly comprises an image acquisition module 51 and an image assessment module 52.

The image acquisition module 51 is configured to acquire an image to be assessed; the image assessment module 52 is configured to input the image to be assessed into an image assessment model to obtain a quality assessment result corresponding to the image to be assessed, wherein the image assessment model comprises: a multilevel transformation network, a fusion network and a fully connected layer, the multilevel transformation network being used for processing the image to be assessed to obtain image features output by each level of transformation network, the fusion network being used for fusing the image features output by the each level of transformation network to obtain a fused image feature, and the fully connected layer being used for processing the fused image feature to obtain the quality assessment result.

The present disclosure relates to an image assessment apparatus for executing the following process: acquiring an image to be assessed; inputting the image to be assessed into an image assessment model to obtain a quality assessment result corresponding to the image to be assessed, wherein the image assessment model comprises: a multilevel transformation network, a fusion network and a fully connected layer, the multilevel transformation network being used for processing the image to be assessed to obtain image features output by each level of transformation network, the fusion network being used for fusing the image features output by the each level of transformation network to obtain a fused image feature, and the fully connected layer being used for processing the fused image feature to obtain the quality assessment result. According to the embodiment of the present disclosure, after a plurality of image features in the image are extracted by the multilevel transformation network, the plurality of image features are fused by using the fusion network, and the image quality is assessed according to the fused feature by using the fully connected layer, improving accuracy and stability of a prediction result.

In an implementation of the present disclosure, the image assessment model further comprises: a sliding window; the sliding window being used for segmenting the input image to be assessed to obtain a plurality of image blocks and inputting the image blocks to the multilevel transformation network.

In an implementation of the present disclosure, the apparatus further comprises: an image division module configured to divide the image to be assessed to obtain a plurality of sub-images to be assessed; a sub-image assessment module configured to, for one or more of the sub-images to be assessed, input the sub-image to be assessed into the image assessment model to obtain a quality assessment result corresponding to the sub-image to be assessed; and an assessment result determination module configured to determine the quality assessment result of the image to be assessed based on the quality assessment results corresponding to the one or more of the sub-images to be assessed.

In an implementation of the present disclosure, the assessment result determination module comprises: a harmonic calculation unit configured to calculate a harmonic mean corresponding to the quality assessment results corresponding to the plurality of sub-images to be assessed; and an assessment result determination unit configured to determine the harmonic mean as the quality assessment result of the image to be assessed.

In an implementation of the present disclosure, the image assessment model is trained by the following modules:
a first quality assessment result determination module configured to input a first sample image in a sample image set to a first branch network comprised in a model to be trained to obtain a first quality assessment result; a second quality assessment result determination module configured to input a second sample image in the sample image set to a second branch network comprised in the model to be trained to obtain a second quality assessment result, wherein the first branch network and the second branch network are twin networks with a same structure, and the first branch network and the second branch network each comprises a multilevel transformation network, a fusion network, and a fully connected layer; and an image recognition model training module configured to train the model to be trained based on the first quality assessment result, the second quality assessment result, labeling information corresponding to the first sample image and labeling information corresponding to the second sample image to obtain a trained image assessment model.

In an implementation of the present disclosure, the apparatus further comprises: a zooming processing module configured to, for at least one sample image in the sample image set, zoom the sample image to obtain a sample image with a preset resolution; and an enhancement processing module configured to preprocess the sample image with the preset resolution by using an enhancement strategy, the enhancement strategy being used for improving richness of the sample image set.

In an implementation of the present disclosure, the enhancement processing module is specifically configured to rotate the sample image with the preset resolution by a preset angle; and/or convert the sample image with the preset resolution into a set color space, wherein, the set color space comprises one or more of: an RGB color space, an HSV color space, an LAB color space, and a Grayscale color space.

In an implementation of the present disclosure, the apparatus further comprises: a labeling information processing module configured to, if the labeling information corresponding to each sample image in the sample image set is unevenly distributed, perform weighted upsampling on the labeling information corresponding to each sample image to obtain labeling information with a weight.

In an implementation of the present disclosure, the image recognition model training module is specifically configured to train the model to be trained by using a joint loss function, based on the first quality assessment result, the second quality assessment result, the labeling information corresponding to the first sample image, and the labeling information corresponding to the second sample image to obtain the trained image assessment model, wherein the joint loss function comprises a regression loss function and a rank loss function, the regression loss function being used for measuring a difference between the first quality assessment result and the labeling information corresponding to the first sample image, and the rank loss function being used for measuring a relative quality between the first sample image and the second sample image.

In an implementation of the present disclosure, the image recognition model training module is specifically configured to determine a first loss function value based on the regression loss function, the first quality assessment result, the second quality assessment result, the labeling information corresponding to the first sample image, and the labeling information corresponding to the second sample image, wherein the first loss function value is used for characterizing a relative difference between the first quality assessment result and the labeling information corresponding to the first sample image, and a relative difference between the second quality assessment result and the labeling information corresponding to the second sample image; determine a second loss function value based on the rank loss function, the first quality assessment result, the second quality assessment result, the labeling information corresponding to the first sample image and the labeling information corresponding to the second sample image, wherein the second loss function value is used for characterizing the relative quality between the first sample image and the second sample image; and optimize a parameter in the model to be trained based on the first loss function value and the second loss function value to obtain the trained image assessment model.

The image assessment apparatus according to the embodiment of the present disclosure may perform the steps performed in the image assessment method according to the embodiment of the present disclosure, and have the beneficial effects of performing the steps, which are not repeated herein.

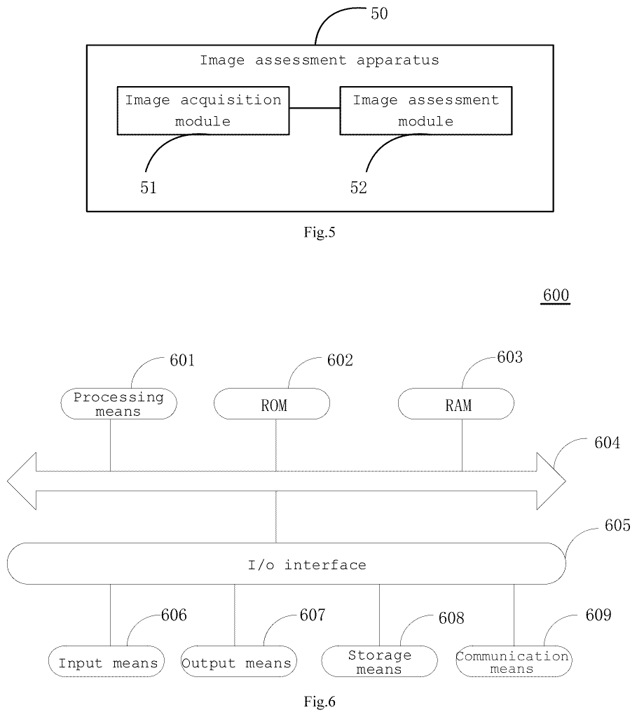

FIG. 6 is a schematic structural diagram of an electronic device according to an embodiment of the present disclosure. Reference is made specifically to FIG. 6 below, which shows a schematic diagram of a structure suitable for implementing an electronic device 600 in an embodiment of the present disclosure. The electronic device 600 in the embodiment of the present disclosure may include, but is not limited to, a mobile terminal such as a mobile phone, notebook computer, digital broadcast receiver, PDA (Personal Digital Assistant), PAD (tablet computer), PMP (portable multimedia player), vehicle-mounted terminal (e.g., vehicle-mounted navigation terminal), and wearable terminal device, and a fixed terminal such as a digital TV, desktop computer, and smart home device. The electronic device shown in FIG. 6 is only an example, and should not bring any limitation to the functions and the scope of use of the embodiment of the present disclosure.

As shown in FIG. 6, the electronic device 600 may comprise a processing means (e.g., a central processing unit, a graphics processing unit, etc.) 601 that may perform various appropriate actions and processes according to a program stored in a read-only memory (ROM) 602 or a program loaded from a storage means 608 into a random access memory (RAM) 603 to implement the image assessment method according to the embodiment of the present disclosure. In the RAM 603, various programs and data required for the operation of the terminal device 600 are also stored. The processing means 601, the ROM 602, and the RAM 603 are connected to each other via a bus 604. An input/output (I/O) interface 605 is also connected to the bus 604.

Generally, the following means may be connected to the I/O interface 605: an input means 606 including, for example, a touch screen, touch pad, keyboard, mouse, camera, microphone, accelerometer, gyroscope, etc.; an output means 607 including, for example, a liquid crystal display (LCD), speaker, vibrator, etc.; the storage means 608 including, for example, a magnetic tape, hard disk, etc.; and a communication means 609. The communication means 609 may allow the terminal device 600 to communicate with other devices wirelessly or by wire to exchange data. While FIG. 6 illustrates the terminal device 600 having various means, it should be understood that not all illustrated means are required to be implemented or provided. More or fewer means may be alternatively implemented or provided.

In particular, according to the embodiment of the present disclosure, the processes described above with reference to the flow diagrams may be implemented as a computer software program. For example, an embodiment of the present disclosure includes a computer program product, which comprises a computer program carried on a non-transitory computer-readable medium, the computer program containing program code for performing the method illustrated by the flow diagrams, thereby implementing the image assessment method as described above. In such an embodiment, the computer program may be downloaded and installed from a network via the communication means 609, or installed from the storage means 608, or installed from the ROM 602. The computer program, when executed by the processing means 601, performs the above functions defined in the method of the embodiment of the present disclosure.

It should be noted that the above computer-readable medium of the present disclosure may be a computer-readable signal medium or a computer-readable storage medium or any combination of the two. The computer-readable storage medium may be, for example, but is not limited to, an electronic, magnetic, optical, electromagnetic, infrared, or semiconductor system, apparatus, or device, or any combination of the foregoing. More specific examples of the computer-readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium may be any tangible medium containing or storing a program, wherein the program can be used by or in conjunction with an instruction execution system, apparatus, or device. However, in the present disclosure, the computer-readable signal medium may include a data signal propagated in baseband or as part of a carrier wave, in which computer-readable program code is carried. Such a propagated data signal may take a variety of forms, including, but not limited to, an electromagnetic signal, optical signal, or any suitable combination of the forgoing. The computer-readable signal medium may also be any computer-readable medium other than the computer-readable storage medium, wherein the computer-readable signal medium can send, propagate, or transmit a program for use by or in conjunction with an instruction execution system, apparatus, or device. The program code contained on the computer-readable medium may be transmitted using any appropriate medium, including but not limited to: a wire, an optical cable, RF (Radio Frequency), etc., or any suitable combination of the foregoing.

In some implementations, a client and a server may communicate using any currently known or future developed network protocol, such as HTTP (HyperText Transfer Protocol), and may be interconnected with any form or medium of digital data communication (e.g., a communication network). Examples of the communication network include a local area network (“LAN”), a wide area network (“WAN”), an internet (e.g., the Internet), and a peer-to-peer network (e.g., an ad hoc peer-to-peer network), as well as any currently known or future developed network.

The above computer-readable medium may be contained in the above electronic device; or may exist separately without being assembled into the electronic device.

The above computer-readable medium has one or more programs carried thereon, wherein the above one or more programs, when executed by the terminal device, cause the terminal device to: acquire an image to be assessed; input the image to be assessed into an image assessment model to obtain a quality assessment result corresponding to the image to be assessed, wherein the image assessment model comprises: a multilevel transformation network, a fusion network and a fully connected layer, the multilevel transformation network being used for processing the image to be assessed to obtain image features output by each level of transformation network, the fusion network being used for fusing the image features output by the each level of transformation network to obtain a fused image feature, and the fully connected layer being used for processing the fused image feature to obtain the quality assessment result.

Optionally, when the above one or more programs are executed by the terminal device, the terminal device may further perform other steps described in the above embodiments.

Computer program code for performing the operation of the present disclosure may be written in one or more programming languages or a combination thereof, wherein the above programming language includes but is not limited to an object-oriented programming language such as Java, Smalltalk, and C++, and also includes a conventional procedural programming language, such as a “C” language or a similar programming language. The program code may be executed entirely on a user's computer, partly on a user's computer, as a stand-alone software package, partly on a user's computer and partly on a remote computer, or entirely on a remote computer or server. In a scenario where a remote computer is involved, the remote computer may be connected to a user's computer through any type of network, including a local area network (LAN) or a wide area network (WAN), or may be connected to an external computer (for example, through the Internet using an Internet service provider).

The flow diagrams and block diagrams in the drawings illustrate the possibly implemented architecture, functions, and operations of the system, method and computer program product according to various embodiments of the present disclosure. In this regard, each block in the flow diagrams or block diagrams may represent a module, program segment, or portion of code, which includes one or more executable instructions for implementing a specified logical function. It should also be noted that, in some alternative implementations, functions noted in blocks may occur in a different order from those noted in the drawings. For example, two blocks shown in succession may, in fact, be executed substantially concurrently, or they may sometimes be executed in a reverse order, which depends upon the functions involved. It will also be noted that each block in the block diagrams and/or flow diagrams, and a combination of the blocks in the block diagrams and/or flow diagrams, can be implemented by a special-purpose hardware-based system that performs specified functions or operations, or by a combination of special-purpose hardware and computer instructions.

The involved units described in the embodiments of the present disclosure may be implemented by software or hardware. The name of the unit does not, in some cases, constitute a limitation on the unit itself.

The functions described above herein may be executed, at least partially, by one or more hardware logic components. For example, without limitation, a hardware logic component of an exemplary type that may be used includes: a field programmable gate array (FPGA), an application specific integrated circuit (ASIC), an application specific standard parts (ASSP), a system on chip (SOC), a complex programmable logic device (CPLD), and the like.

In the context of this disclosure, the machine-readable medium may be a tangible medium, which can contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to one or more embodiments of the present disclosure, there is provided an image assessment method comprising: acquiring an image to be assessed; inputting the image to be assessed into an image assessment model to obtain a quality assessment result corresponding to the image to be assessed, wherein the image assessment model comprises: a multilevel transformation network, a fusion network and a fully connected layer, the multilevel transformation network being configured for processing the image to be assessed to obtain image features output by each level of transformation network, the fusion network being configured for fusing the image features output by the each level of transformation network to obtain a fused image feature, and the fully connected layer being configured for processing the fused image feature to obtain the quality assessment result.

According to one or more embodiments of the present disclosure, there is provided an image assessment method, wherein the image assessment model further comprises: a sliding window; the sliding window being configured for segmenting the input image to be assessed to obtain a plurality of image blocks and inputting the image blocks to the multilevel transformation network.

According to one or more embodiments of the present disclosure, there is provided an image assessment method, wherein the method further comprises: dividing the image to be assessed to obtain a plurality of sub-images to be assessed; for one or more of the sub-images to be assessed, inputting the sub-image to be assessed into the image assessment model to obtain a quality assessment result corresponding to the sub-image to be assessed; and determining the quality assessment result of the image to be assessed based on the quality assessment results corresponding to the one or more of the sub-images to be assessed.

According to one or more embodiments of the present disclosure, there is provided an image assessment method, wherein the determining the quality assessment result of the image to be assessed based on the quality assessment results corresponding to the plurality of sub-images to be assessed comprises: calculating a harmonic mean corresponding to the quality assessment results corresponding to the plurality of sub-images to be assessed; and determining the harmonic mean as the quality assessment result of the image to be assessed.

According to one or more embodiments of the present disclosure, there is provided an image assessment method, wherein the image assessment model is trained by: inputting a first sample image in a sample image set to a first branch network comprised in a model to be trained to obtain a first quality assessment result; inputting a second sample image in the sample image set to a second branch network comprised in the model to be trained to obtain a second quality assessment result, wherein the first branch network and the second branch network are twin networks with a same structure, and the first branch network and the second branch network each comprises a multilevel transformation network, a fusion network and a fully connected layer; and training the model to be trained based on the first quality assessment result, the second quality assessment result, labeling information corresponding to the first sample image and labeling information corresponding to the second sample image to obtain a trained image assessment model.

According to one or more embodiments of the present disclosure, there is provided an image assessment method, wherein the method further comprises: for at least one sample image in the sample image set, zooming the sample image to obtain a sample image with a preset resolution; and preprocessing the sample image with the preset resolution by using an enhancement strategy, the enhancement strategy being configured for improving richness of the sample image set.

According to one or more embodiments of the present disclosure, there is provided an image assessment method, wherein the preprocessing the sample image with the preset resolution by using the enhancement strategy, comprises at least one of: rotating the sample image with the preset resolution by a preset angle; or converting the sample image with the preset resolution into a set color space, wherein, the set color space comprises one or more of: an RGB color space, an HSV color space, an LAB color space, and a Grayscale color space.

According to one or more embodiments of the present disclosure, there is provided an image assessment method, wherein the method further comprises: if the labeling information corresponding to each sample image in the sample image set is unevenly distributed, performing weighted upsampling on the labeling information corresponding to each sample image to obtain labeling information with a weight.

According to one or more embodiments of the present disclosure, there is provided an image assessment method, wherein the training the model to be trained based on the first quality assessment result, the second quality assessment result, the labeling information corresponding to the first sample image, and the labeling information corresponding to the second sample image to obtain the trained image assessment model, comprises: training the model to be trained by using a joint loss function based on the first quality assessment result, the second quality assessment result, the labeling information corresponding to the first sample image, and the labeling information corresponding to the second sample image to obtain the trained image assessment model, wherein the joint loss function comprises a regression loss function and a rank loss function, the regression loss function being configured for measuring a difference between the first quality assessment result and the labeling information corresponding to the first sample image, and the rank loss function being configured for measuring a relative quality between the first sample image and the second sample image.

According to one or more embodiments of the present disclosure, there is provided an image assessment method, wherein the training the model to be trained by using the joint loss function based on the first quality assessment result, the second quality assessment result, the labeling information corresponding to the first sample image, and the labeling information corresponding to the second sample image to obtain the trained image assessment model, comprises: determining a first loss function value based on the regression loss function, the first quality assessment result, the second quality assessment result, the labeling information corresponding to the first sample image, and the labeling information corresponding to the second sample image, wherein the first loss function value is configured for characterizing a relative difference between the first quality assessment result and the labeling information corresponding to the first sample image, and a relative difference between the second quality assessment result and the labeling information corresponding to the second sample image; determining a second loss function value based on the rank loss function, the first quality assessment result, the second quality assessment result, the labeling information corresponding to the first sample image, and the labeling information corresponding to the second sample image, wherein the second loss function value is configured for characterizing the relative quality between the first sample image and the second sample image; and optimizing a parameter in the model to be trained based on the first loss function value and the second loss function value to obtain the trained image assessment model.

According to one or more embodiments of the present disclosure, there is provided an image assessment apparatus, comprising: an image acquisition module configured to acquire an image to be assessed; an image assessment module configured to input the image to be assessed to an image assessment model to obtain a quality assessment result corresponding to the image to be assessed, wherein the image assessment model comprises: a multilevel transformation network, a fusion network and a fully connected layer, the multilevel transformation network being configured for processing the image to be assessed to obtain image features output by each level of transformation network, the fusion network being configured for fusing the image features output by the each level of transformation network to obtain a fused image feature, and the fully connected layer being configured for processing the fused image feature to obtain the quality assessment result.

According to one or more embodiments of the present disclosure, there is provided an image assessment apparatus, wherein the image assessment model further comprises: a sliding window; the sliding window being configured for segmenting the input image to be assessed to obtain a plurality of image blocks and inputting the image blocks to the multilevel transformation network.

According to one or more embodiments of the present disclosure, there is provided an image assessment apparatus, wherein the apparatus further comprises: an image division module configured to divide the image to be assessed to obtain a plurality of sub-images to be assessed; a sub-image assessment module configured to, for one or more of the sub-images to be assessed, input the sub-image to be assessed into the image assessment model to obtain a quality assessment result corresponding to the sub-image to be assessed; and an assessment result determination module configured to determine the quality assessment result of the image to be assessed based on the quality assessment results corresponding to the one or more of the sub-images to be assessed.

According to one or more embodiments of the present disclosure, there is provided an image assessment apparatus, wherein the assessment result determination module comprises: a harmonic calculation unit configured to calculate a harmonic mean corresponding to the quality assessment results corresponding to the plurality of sub-images to be assessed; and an assessment result determination unit configured to determine the harmonic mean as the quality assessment result of the image to be assessed.

According to one or more embodiments of the present disclosure, there is provided an image assessment apparatus, wherein the image assessment model is trained by: a first quality assessment result determination module configured to input a first sample image in a sample image set to a first branch network comprised in a model to be trained to obtain a first quality assessment result; a second quality assessment result determination module configured to input a second sample image in the sample image set to a second branch network comprised in the model to be trained to obtain a second quality assessment result, wherein the first branch network and the second branch network are twin networks with a same structure, and the first branch network and the second branch network each comprises a multilevel transformation network, a fusion network and a fully connected layer; and an image recognition model training module configured to train the model to be trained based on the first quality assessment result, the second quality assessment result, labeling information corresponding to the first sample image and labeling information corresponding to the second sample image to obtain a trained image assessment model.

According to one or more embodiments of the present disclosure, there is provided an image assessment apparatus, wherein the apparatus further comprises: a zooming processing module configured to, for at least one sample image in the sample image set, zoom the sample image to obtain a sample image with a preset resolution; and an enhancement processing module configured to preprocess the sample image with the preset resolution by using an enhancement strategy, the enhancement strategy being configured for improving richness of the sample image set.

According to one or more embodiments of the present disclosure, there is provided an image assessment apparatus, wherein the enhancement processing module is specifically configured to rotate the sample image with the preset resolution by a preset angle; and/or convert the sample image with the preset resolution into a set color space, wherein, the set color space comprises one or more of: an RGB color space, an HSV color space, an LAB color space, and a Grayscale color space.

According to one or more embodiments of the present disclosure, there is provided an image assessment apparatus, wherein the apparatus further comprises: labeling information processing module configured to, if the labeling information corresponding to each sample image in the sample image set is unevenly distributed, perform weighted upsampling on the labeling information corresponding to each sample image to obtain labeling information with a weight.

According to one or more embodiments of the present disclosure, there is provided an image assessment apparatus, wherein the image recognition model training module is specifically configured to train the model to be trained by using a joint loss function based on the first quality assessment result, the second quality assessment result, the labeling information corresponding to the first sample image, and the labeling information corresponding to the second sample image to obtain the trained image assessment model, wherein the joint loss function comprises a regression loss function and a rank loss function, the regression loss function being configured for measuring a difference between the first quality assessment result and the labeling information corresponding to the first sample image, and the rank loss function being configured for determining a relative quality between the first sample image and the second sample image.

According to one or more embodiments of the present disclosure, there is provided an image assessment apparatus, wherein the image recognition model training module is specifically configured to determine a first loss function value based on the regression loss function, the first quality assessment result, the second quality assessment result, the labeling information corresponding to the first sample image, and the labeling information corresponding to the second sample image, wherein the first loss function value is configured for characterizing a relative difference between the first quality assessment result and the labeling information corresponding to the first sample image, and a relative difference between the second quality assessment result and the labeling information corresponding to the second sample image; determine a second loss function value based on the rank loss function, the first quality assessment result, the second quality assessment result, the labeling information corresponding to the first sample image, and the labeling information corresponding to the second sample image, wherein the second loss function value is configured for characterizing the relative quality between the first sample image and the second sample image; and optimize a parameter in the model to be trained based on the first loss function value and the second loss function value to obtain the trained image assessment model.

According to one or more embodiments of the present disclosure, there is provided an electronic device, comprising:
one or more processors; and
a memory configured to store one or more programs,
the one or more programs, when executed by the one or more processors, causing the one or more processors to implement any of the image assessment methods according to the present disclosure.

According to one or more embodiments of the present disclosure, there is provided a computer-readable storage medium having thereon stored a computer program which, when executed by a processor, implements any of the image assessment methods according to the present disclosure.

An embodiment of the present disclosure further provides a computer program product, comprising a computer program or instructions which, when executed by a processor, implement the image assessment method as described above.

An embodiment of the present disclosure further provides a computer program, comprising instructions which, when executed by a processor, cause the processor to implement the image assessment method as described above.

The foregoing description is only illustration of the preferred embodiments of the present disclosure and the technical principles employed. It should be appreciated by those skilled in the art that the disclosure scope involved in the present disclosure is not limited to the technical solutions formed by specific combinations of the technical features described above, but also encompasses other technical solutions formed by arbitrary combinations of the above technical features or equivalent features thereof without departing from the above disclosed concepts, for example, a technical solution formed by performing mutual replacement between the above features and technical features having similar functions to those disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing might be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Rather, the specific features and actions described above are only example forms of implementing the claims.

1. An image assessment method, comprising:
acquiring an image to be assessed; and
inputting the image to be assessed into an image assessment model to obtain a quality assessment result corresponding to the image to be assessed, wherein the image assessment model comprises: a multilevel transformation network, a fusion network and a fully connected layer, the multilevel transformation network being configured for processing the image to be assessed to obtain image features output by each level of transformation network, the fusion network being configured for fusing the image features output by the each level of transformation network to obtain a fused image feature, and the fully connected layer being configured for processing the fused image feature to obtain the quality assessment result.

2. The method according to claim 1, wherein the image assessment model further comprises: a sliding window;
the sliding window being configured for segmenting the input image to be assessed to obtain a plurality of image blocks and inputting the image blocks to the multilevel transformation network.

3. The method according to claim 1, wherein the method further comprises:
dividing the image to be assessed to obtain a plurality of sub-images to be assessed;
for one or more of the sub-images to be assessed, inputting the sub-image to be assessed into the image assessment model to obtain a quality assessment result corresponding to the sub-image to be assessed; and
determining the quality assessment result of the image to be assessed based on the quality assessment results corresponding to the one or more of the sub-images to be assessed.

4. The method according to claim 3, wherein the determining the quality assessment result of the image to be assessed based on the quality assessment results corresponding to the plurality of sub-images to be assessed, comprises:
calculating a harmonic mean corresponding to the quality assessment results corresponding to the plurality of sub-images to be assessed; and
determining the harmonic mean as the quality assessment result of the image to be assessed.

5. The method according to claim 1, wherein the image assessment model is trained by:
inputting a first sample image in a sample image set to a first branch network comprised in a model to be trained to obtain a first quality assessment result;
inputting a second sample image in the sample image set to a second branch network comprised in the model to be trained to obtain a second quality assessment result, wherein the first branch network and the second branch network are twin networks with a same structure, and the first branch network and the second branch network each comprises a multilevel transformation network, a fusion network and a fully connected layer; and
training the model to be trained based on the first quality assessment result, the second quality assessment result, labeling information corresponding to the first sample image and labeling information corresponding to the second sample image to obtain a trained image assessment model.

6. The method according to claim 5, wherein the method further comprises:
for at least one sample image in the sample image set, zooming the sample image to obtain a sample image with a preset resolution; and
preprocessing the sample image with the preset resolution by using an enhancement strategy, the enhancement strategy being configured for improving richness of the sample image set.

7. The method according to claim 6, wherein the preprocessing the sample image with the preset resolution by using the enhancement strategy, comprises at least one of:
rotating the sample image with the preset resolution by a preset angle; or
converting the sample image with the preset resolution into a set color space.

8. The method according to claim 7, wherein the set color space comprises one or more of: an RGB color space, an HSV color space, an LAB color space, and a Grayscale color space.

9. The method according to claim 5, wherein the method further comprises:
if the labeling information corresponding to each sample image in the sample image set is unevenly distributed, performing weighted upsampling on the labeling information corresponding to each sample image to obtain labeling information with a weight.

10. The method according to claim 5, wherein the training the model to be trained based on the first quality assessment result, the second quality assessment result, the labeling information corresponding to the first sample image, and the labeling information corresponding to the second sample image to obtain the trained image assessment model, comprises:
training the model to be trained by using a joint loss function based on the first quality assessment result, the second quality assessment result, the labeling information corresponding to the first sample image, and the labeling information corresponding to the second sample image to obtain the trained image assessment model, wherein the joint loss function comprises a regression loss function and a rank loss function, the regression loss function being configured for measuring a difference between the first quality assessment result and the labeling information corresponding to the first sample image, and the rank loss function being configured for measuring a relative quality between the first sample image and the second sample image.

11. The method according to claim 10, wherein the training the model to be trained by using the joint loss function based on the first quality assessment result, the second quality assessment result, the labeling information corresponding to the first sample image, and the labeling information corresponding to the second sample image to obtain the trained image assessment model, comprises:
determining a first loss function value based on the regression loss function, the first quality assessment result, the second quality assessment result, the labeling information corresponding to the first sample image, and the labeling information corresponding to the second sample image, wherein the first loss function value is configured for characterizing a relative difference between the first quality assessment result and the labeling information corresponding to the first sample image, and a relative difference between the second quality assessment result and the labeling information corresponding to the second sample image;
determining a second loss function value based on the rank loss function, the first quality assessment result, the second quality assessment result, the labeling information corresponding to the first sample image, and the labeling information corresponding to the second sample image, wherein the second loss function value is configured for characterizing the relative quality between the first sample image and the second sample image; and
optimizing a parameter in the model to be trained based on the first loss function value and the second loss function value to obtain the trained image assessment model.

12. (canceled)

13. An electronic device, comprising:
one or more processors; and
a storage device configured to store one or more programs,
the one or more programs, when executed by the one or more processors, causing the one or more processors to implement a method comprising:
acquiring an image to be assessed; and
inputting the image to be assessed into an image assessment model to obtain a quality assessment result corresponding to the image to be assessed, wherein the image assessment model comprises: a multilevel transformation network, a fusion network and a fully connected layer, the multilevel transformation network being configured for processing the image to be assessed to obtain image features output by each level of transformation network, the fusion network being configured for fusing the image features output by the each level of transformation network to obtain a fused image feature, and the fully connected layer being configured for processing the fused image feature to obtain the quality assessment result.

14. A non-transitory computer-readable storage medium having thereon stored a computer program which, when executed by a processor, implements a method comprising:
acquiring an image to be assessed; and
inputting the image to be assessed into an image assessment model to obtain a quality assessment result corresponding to the image to be assessed, wherein the image assessment model comprises: a multilevel transformation network, a fusion network and a fully connected layer, the multilevel transformation network being configured for processing the image to be assessed to obtain image features output by each level of transformation network, the fusion network being configured for fusing the image features output by the each level of transformation network to obtain a fused image feature, and the fully connected layer being configured for processing the fused image feature to obtain the quality assessment result.

15-16. (canceled)

17. The electronic device according to claim 13, wherein the image assessment model further comprises: a sliding window;
the sliding window being configured for segmenting the input image to be assessed to obtain a plurality of image blocks and inputting the image blocks to the multilevel transformation network.

18. The electronic device according to claim 13, wherein the method further comprises:
dividing the image to be assessed to obtain a plurality of sub-images to be assessed;
for one or more of the sub-images to be assessed, inputting the sub-image to be assessed into the image assessment model to obtain a quality assessment result corresponding to the sub-image to be assessed; and
determining the quality assessment result of the image to be assessed based on the quality assessment results corresponding to the one or more of the sub-images to be assessed.

19. The electronic device according to claim 18, wherein the determining the quality assessment result of the image to be assessed based on the quality assessment results corresponding to the plurality of sub-images to be assessed, comprises:
calculating a harmonic mean corresponding to the quality assessment results corresponding to the plurality of sub-images to be assessed; and
determining the harmonic mean as the quality assessment result of the image to be assessed.

20. The electronic device according to claim 13, wherein the image assessment model is trained by:
inputting a first sample image in a sample image set to a first branch network comprised in a model to be trained to obtain a first quality assessment result;
inputting a second sample image in the sample image set to a second branch network comprised in the model to be trained to obtain a second quality assessment result, wherein the first branch network and the second branch network are twin networks with a same structure, and the first branch network and the second branch network each comprises a multilevel transformation network, a fusion network and a fully connected layer; and
training the model to be trained based on the first quality assessment result, the second quality assessment result, labeling information corresponding to the first sample image and labeling information corresponding to the second sample image to obtain a trained image assessment model.

21. The electronic device according to claim 20, wherein the method further comprises:
for at least one sample image in the sample image set, zooming the sample image to obtain a sample image with a preset resolution; and
preprocessing the sample image with the preset resolution by using an enhancement strategy, the enhancement strategy being configured for improving richness of the sample image set.

22. The electronic device according to claim 21, wherein the preprocessing the sample image with the preset resolution by using the enhancement strategy, comprises at least one of:
rotating the sample image with the preset resolution by a preset angle; or
converting the sample image with the preset resolution into a set color space.

23. The electronic device according to claim 22, wherein the set color space comprises one or more of: an RGB color space, an HSV color space, an LAB color space, and a Grayscale color space.
